(19) United States
(12) Patent Application Publication
(10) Pub. No.: US 2026/0269275 A1
(43) Pub. Date: Sep. 10, 2026

(54) SECONDARY BATTERY AND ELECTRONIC DEVICE

(71) Applicant: Ningde Amperex Technology Limited, Ningde (CN)

(72) Inventors: Lilan ZHANG, Ningde (CN); Xiexue PENG, Ningde (CN); Chao TANG, Ningde (CN)

(73) Assignee: Ningde Amperex Technology Limited, Ningde (CN)

(21) Appl. No.: 19/657,422

(22) Filed: Apr. 24, 2026

Related U.S. Application Data
(63) Continuation of application No. PCT/CN2024/116253, filed on Sep. 2, 2024.

(30) Foreign Application Priority Data
Oct. 25, 2023 (CN) 202311394244.8

(51) Int. Cl. H01M 4/66; H01M 4/02; H01M 4/133; H01M 4/134; H01M 4/36; H01M 4/38; H01M 4/583; H01M 10/0525; H01M 10/0567

(52) U.S. Cl. CPC H01M 4/667; H01M 4/133; H01M 4/134; H01M 4/364; H01M 4/386; H01M 4/583; H01M 4/663; H01M 4/668; H01M 10/0525; H01M 10/0567; H01M 2004/021; H01M 2004/027

(57) ABSTRACT

A secondary battery includes a positive electrode plate, a negative electrode plate, and an electrolyte. The positive electrode plate includes a positive electrode current collector, an undercoating layer, and a positive electrode active material layer, where the undercoating layer is disposed between the positive electrode current collector and the positive electrode active material layer. The undercoating layer includes an inorganic metal oxide, where element M in the inorganic metal oxide includes at least one of Al, Ti, Sn, Sb, or Mg, and a mass percentage W1 of the inorganic metal oxide is from 55% to 99%. A first compound in the electrolyte includes at least one of fluorinated ethylene carbonate, difluorinated ethylene carbonate, or a compound represented by formula (I), formula (II), or formula (III), with a mass percentage of the first compound being a %, where 0.15≤a≤21.

### CROSS REFERENCE TO THE RELATED APPLICATIONS

This application is a continuation under 35 U.S.C. § 120 of international patent application PCT/CN2024/116253 filed on Sep. 2, 2024, which claims priority to Chinese Patent Application No. 202311394244.8, filed on Oct. 25, 2023 and entitled “SECONDARY BATTERY AND ELECTRONIC DEVICE,” the entire contents of which are incorporated herein by reference.

### TECHNICAL FIELD

This application relates to the field of electrochemical technology, and more particularly, to a secondary battery and an electronic device.

### BACKGROUND

Secondary batteries (for example, lithium-ion batteries) are widely used due to their high energy density and long cycle life. Currently, additives that significantly improve cycling performance in lithium-ion battery electrolytes include carbonate types, sulfate types, anhydride types, phosphate types, sulfonate types, borate types, and silicate types.

When additives such as carbonate types, sulfate types, or anhydride types are used, some of these additives readily react with trace water in the electrolyte to form acidic substances, particularly at high temperatures (for example, temperatures greater than or equal to 45° C.). These acidic substances easily corrode aluminum foil, reducing the toughness of the aluminum foil. Additionally, the acidic substances corrode the surface of the positive electrode active material, causing phase changes in the positive electrode active material particles, leading to greater volume swelling and severe deformation of the aluminum foil. The reduced toughness or deformation of the aluminum foil results in decreased safety performance of the lithium-ion battery.

### SUMMARY

A purpose of this application is to provide a secondary battery and an electronic device that improve the safety performance of the secondary battery while ensuring the cycling stability of the secondary battery. The specific technical solutions are as follows:

A first aspect of this application provides a secondary battery including a positive electrode plate, a negative electrode plate, and an electrolyte. The positive electrode plate includes a positive electrode current collector, and an undercoating layer and a positive electrode active material layer that are disposed on at least one surface of the positive electrode current collector, where the undercoating layer is disposed between the positive electrode current collector and the positive electrode active material layer. The undercoating layer includes an inorganic metal oxide, where the inorganic metal oxide includes element M, and the element M includes at least one of Al, Ti, Sn, Sb, or Mg. Preferably, the element M includes at least one of Ti, Sn, or Sb. Based on a mass of the undercoating layer, a mass percentage of the inorganic metal oxide is W1, where 55%≤W1≤99%, preferably 60%≤W1≤85%.

The electrolyte includes a first compound, where the first compound includes at least one of fluorinated ethylene carbonate, difluorinated ethylene carbonate, a compound represented by formula (I), a compound represented by formula (II), or a compound represented by formula (III),

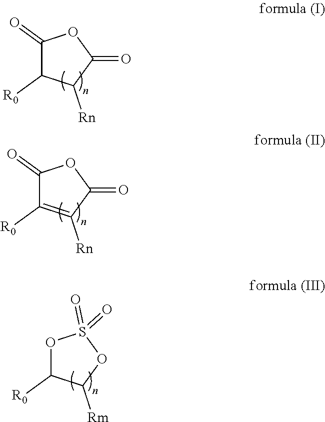

where n and m are independently selected from integers from 1 to 3, and R₀, Rn, and Rm are each independently selected from hydrogen, fluorine, a substituted or unsubstituted C1-C6 alkyl group, or a substituted or unsubstituted C2-C6 alkenyl group; and during substitution, a substituent of each group is a halogen.

Based on the mass of the electrolyte, a mass percentage of the first compound is a %, where 0.15≤a≤21, preferably 0.5≤a≤12. By controlling the undercoating layer of the positive electrode plate to include an inorganic metal oxide, and the mass percentage of the inorganic metal oxide, the type of element included in the inorganic metal oxide, and the type and mass percentage of the first compound in the electrolyte to be within the ranges of this application, the safety performance of the secondary battery can be improved while ensuring the cycling stability of the secondary battery.

In one embodiment of this application, the thickness of the undercoating layer is A μm, where 2.1≤A≤15.5, preferably 2.5≤A≤9.5. By controlling the value of A within the range of this application, the undercoating layer can have a proper thickness, effectively inhibiting corrosion of the positive electrode current collector by acidic substances while ensuring the energy density of the secondary battery and improving the safety performance of the secondary battery.

In one embodiment of this application, 0.02≤a/A≤5.1. By controlling the value of a/A within the range of this application, the mass percentage of the first compound can be matched with the thickness of the undercoating layer, effectively inhibiting corrosion of the positive electrode current collector by acidic substances, thereby improving the safety performance of the secondary battery while ensuring the cycling stability of the secondary battery.

In one embodiment of this application, the compound represented by formula (I) includes at least one of succinic anhydride, glutaric anhydride, or adipic anhydride; the compound represented by formula (II) includes at least one of maleic anhydride, citraconic anhydride, trifluoromethyl maleic anhydride, dimethyl maleic anhydride, 3-fluorofuran-2,5-dione, or 3,4-difluoromaleic anhydride; and the compound represented by formula (III) includes at least one of ethylene sulfate, propylene sulfate, butylene sulfate, 1,3,2-dioxathiane-2,2-dioxide, or 2-methyl-1,3-propane disulfonate. By selecting the compound represented by formula (I), the compound represented by formula (II), or the compound represented by formula (III) as described above, the safety performance of the secondary battery can be improved while ensuring the cycling stability of the secondary battery.

In one embodiment of this application, the inorganic metal oxide includes at least one of Al₂O₃, TiO₂, SnO₂, SnO, Sb₂O₃, Sb₂O₄, Sb₂O₅, or MgO. By selecting the above inorganic metal oxides, these inorganic metal oxides can react with acidic substances, reducing the content of acidic substances and reducing corrosion of the positive electrode current collector and positive electrode active material by the acidic substances, thereby improving the safety performance of the secondary battery while ensuring the cycling stability of the secondary battery.

In one embodiment of this application, the undercoating layer further includes a binder and a conductive agent. Based on the mass of the undercoating layer, a mass percentage of the binder is W2, and a mass percentage of the conductive agent is W3, where 0.5%≤W2≤25%, and 0.5%≤W3≤20%. By controlling the values of W2 and W3 to be within the ranges of this application, the mass percentage of the binder and the mass percentage of the conductive agent are within proper ranges, allowing the inorganic metal oxide to have a proper mass percentage, which facilitates effective protection of the positive electrode current collector. Additionally, it enables good adhesion between the inorganic metal oxide and the positive electrode current collector, providing the positive electrode plate with relatively high electron conductivity, thereby improving the safety performance of the secondary battery while ensuring the cycling stability of the secondary battery.

In one embodiment of this application, the binder satisfies at least one of the following characteristics:
(1) the binder includes a polymer formed by monomers of at least one acrylic acid, acrylamide, lithium acrylate, sodium acrylate, acrylonitrile, methyl acrylate, ethyl acrylate, methyl 2-methacrylate, or ethyl 2-methacrylate;
(2) the binder includes at least one of sodium carboxymethyl cellulose, potassium carboxymethyl cellulose, or nitrile rubber; or
(3) a weight-average molecular weight of the binder is from 150,000 to 1,950,000.

In one embodiment of this application, the conductive agent includes at least one of graphene, graphite fibers, carbon nanotubes, or conductive carbon black. By selecting the above conductive agents, the positive electrode plate can have relatively high electron conductivity, which is beneficial to improving the cycling performance of the secondary battery.

In one embodiment of this application, the negative electrode plate includes a negative electrode active material, where the negative electrode active material includes at least one of natural graphite, artificial graphite, mesocarbon microbeads, hard carbon, soft carbon, silicon, or silicon-based composite materials. With the negative electrode plate including the above negative electrode active materials, the secondary battery exhibits relatively high cycling stability and good safety performance.

A second aspect of this application provides an electronic device including the secondary battery according to any one of the above embodiments. Therefore, the electronic device provided by this application exhibits good usage performance.

Beneficial effects of this application:
This application provides a secondary battery and an electronic device. The secondary battery includes a positive electrode plate, a negative electrode plate, and an electrolyte. The positive electrode plate includes a positive electrode current collector, and an undercoating layer and a positive electrode active material layer that are disposed on at least one surface of the positive electrode current collector, where the undercoating layer is disposed between the positive electrode current collector and the positive electrode active material layer. The undercoating layer includes an inorganic metal oxide, where the inorganic metal oxide includes element M, and the element M includes at least one of Al, Ti, Sn, Sb, or Mg. Based on the mass of the undercoating layer, the mass percentage of the inorganic metal oxide is W1, where 55%≤W1≤99%. The electrolyte includes a first compound, where the first compound includes at least one of fluorinated ethylene carbonate, difluorinated ethylene carbonate, a compound represented by formula (I), a compound represented by formula (II), or a compound represented by formula (III). Based on the mass of the electrolyte, the mass percentage of the first compound is a %, where 0.15≤a≤21. By controlling the undercoating layer of the positive electrode plate to include an inorganic metal oxide, and the mass percentage of the inorganic metal oxide, the type of element included in the inorganic metal oxide, and the type and mass percentage of the first compound in the electrolyte to be within the ranges of this application, the safety performance of the secondary battery can be improved while ensuring the cycling stability of the secondary battery.

Certainly, implementing any product or method of this application does not necessarily achieve all the advantages described above simultaneously.

### BRIEF DESCRIPTION OF DRAWINGS

To more clearly illustrate the technical solutions of some embodiments of this application or the prior art, the drawings required for describing these embodiments or the prior art are briefly described below. It is apparent that the drawings described below are merely some embodiments of this application, and those skilled in the art can obtain other embodiments based on these drawings.

FIG. 1 is a schematic diagram of a positive electrode plate according to one embodiment of this application.

### DETAILED DESCRIPTION

The technical solutions in some embodiments of this application will be clearly and completely described below in conjunction with the drawings in these embodiments of this application. It is apparent that the described embodiments are only some embodiments of this application, not all embodiments. All other embodiments obtained by those skilled in the art based on this application fall within the scope of protection of this application.

It should be noted that, in some embodiments of this application, a lithium-ion battery is used as an example of a secondary battery to explain this application, but the secondary battery of this application is not limited to lithium-ion batteries.

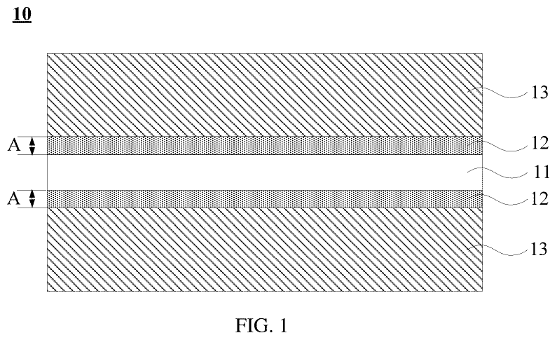

This application provides a secondary battery including a positive electrode plate, a negative electrode plate, and an electrolyte. The positive electrode plate includes a positive electrode current collector, and an undercoating layer and a positive electrode active material layer that are disposed on at least one surface of the positive electrode current collector, where the undercoating layer is disposed between the positive electrode current collector and the positive electrode active material layer. As shown in FIG. 1, the positive electrode plate 10 includes a positive electrode current collector 11, with an undercoating layer 12 and a positive electrode active material layer 13 sequentially disposed on both surfaces of the positive electrode current collector 11. The undercoating layer includes an inorganic metal oxide, where the inorganic metal oxide includes element M, and the element M includes at least one of Al, Ti, Sn, Sb, or Mg. Preferably the element M includes at least one of Ti, Sn, or Sb. Based on the mass of the undercoating layer, the mass percentage of the inorganic metal oxide is W1, where 55%≤W1≤99%, preferably 60%≤W1≤85%. Exemplarily, W1 may be 55%, 60%, 65%, 70%, 75%, 80%, 85%, 90%, 95%, 99%, or any range composed of any two of these values.

The electrolyte includes a first compound, where the first compound includes at least one of fluorinated ethylene carbonate, difluorinated ethylene carbonate, a compound represented by formula (I), a compound represented by formula (II), or a compound represented by formula (III),

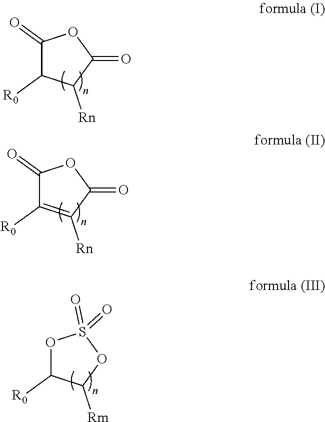

where n and m are independently selected from integers from 1 to 3, and R₀, Rn, and Rm are each independently selected from hydrogen, fluorine, a substituted or unsubstituted C1-C6 alkyl group, or a substituted or unsubstituted C2-C6 alkenyl group; and during substitution, a substituent of each group is a halogen.

Based on the mass of the electrolyte, a mass percentage of the first compound is a %, where 0.15≤a≤21, preferably 0.5≤a≤12. Exemplarily, a may be 0.15, 0.5, 1, 2, 3, 4, 5, 6, 7, 8, 9, 10, 11, 12, 13, 14, 15, 16, 17, 18, 19, 20, 21, or any range composed of any two of these values. In this application, the first compound serves as an additive.

In this application, when the first compound includes two or more types, there is no particular restriction on the mass percentage of each type, as long as the total mass percentage of the first compound satisfies the range of this application.

The inventors have found that when additives in the electrolyte of a secondary battery, such as carbonate types, sulfate types, or anhydride types, are used, some of these additives easily react with trace water in the electrolyte during high temperatures or cycling processes to form acidic substances. These acidic substances easily corrode the positive electrode current collector and cause swelling of the positive electrode active material, leading to reduced safety performance of the secondary battery. By providing an undercoating layer on the positive electrode current collector, where the undercoating layer includes an inorganic metal oxide, the inorganic metal oxide can react with acidic substances, acting as a sacrificial agent to reduce the content of acidic substances, thereby reducing corrosion of the positive electrode current collector and the positive electrode active material by the acidic substances. This mitigates deformation of the positive electrode current collector due to swelling of the positive electrode active material and the reduction in toughness of the positive electrode current collector due to corrosion of the positive electrode current collector. Additionally, the undercoating layer being disposed on the positive electrode current collector also reduces direct contact between the electrolyte and the positive electrode current collector, providing a protective effect, thereby improving the safety performance of the secondary battery while ensuring the cycling stability of the secondary battery. By controlling the undercoating layer of the positive electrode plate to include an inorganic metal oxide, and the mass percentage of the inorganic metal oxide, the type of element included in the inorganic metal oxide, and the type and mass percentage of the first compound in the electrolyte to be within the ranges of this application, the safety performance of the secondary battery can be improved while ensuring the cycling stability of the secondary battery.

In one embodiment of this application, as shown in FIG. 1, the thickness of the undercoating layer 12 is A μm, where 2.1≤A≤15.5, preferably 2.5≤A≤9.5. Exemplarily, A may be 2.1, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, or any range composed of any two of these values. By controlling the value of A within the range of this application, the undercoating layer can have a proper thickness, effectively inhibiting corrosion of the positive electrode current collector by acidic substances while ensuring the energy density of the secondary battery and improving the safety performance of the secondary battery.

In one embodiment of this application, 0.02≤a/A≤5.1. Exemplarily, a/A may be 0.02, 0.05, 0.1, 0.5, 1, 1.5, 2, 2.5, 3, 3.5, 4, 4.5, 5, 5.1, or any range composed of any two of these values. By controlling the value of a/A within the range of this application, the mass percentage of the first compound can be matched with the thickness of the undercoating layer, effectively inhibiting corrosion of the positive electrode current collector by acidic substances, thereby improving the safety performance of the secondary battery while ensuring the cycling stability of the secondary battery.

In one embodiment of this application, the compound represented by formula (I) includes at least one of succinic anhydride, glutaric anhydride, or adipic anhydride; the compound represented by formula (II) includes at least one of maleic anhydride, citraconic anhydride, trifluoromethyl maleic anhydride, dimethyl maleic anhydride, 3-fluorofuran-2,5-dione, or 3,4-difluoromaleic anhydride; and the compound represented by formula (III) includes at least one of ethylene sulfate, propylene sulfate, butylene sulfate, 1,3,2-dioxathiane-2,2-dioxide, or 2-methyl-1,3-propane disulfonate. By selecting the compound represented by formula (I), the compound represented by (II), or the compound represented by (III) as described above, the safety performance of the secondary battery can be improved while ensuring the cycling stability of the secondary battery.

In one embodiment of this application, the inorganic metal oxide includes at least one of Al₂O₃, TiO₂, SnO₂, SnO, Sb₂O₃, Sb₂O₄, Sb₂O₅, or MgO. By selecting the above inorganic metal oxides, these inorganic metal oxide oxides can react with acidic substances, reducing the content of acidic substances and reducing corrosion of the positive electrode current collector and positive electrode active material, thereby improving the safety performance of the secondary battery while ensuring the cycling stability of the secondary battery.

In one embodiment of this application, the undercoating layer further includes a binder and a conductive agent. Based on the mass of the undercoating layer, a mass percentage of the binder is W2, and a mass percentage of the conductive agent is W3, where 0.5%≤W2≤25%. Exemplarily, W2 may be 0.5%, 1%, 3%, 5%, 7%, 9%, 10%, 11%, 13%, 15%, 17%, 19%, 20%, 21%, 23%, 25%, or any range composed of any two of these values; and 0.5%≤W3≤20%. Exemplarily, W3 may be 0.5%, 1%, 3%, 5%, 7%, 9%, 10%, 11%, 13%, 15%, 17%, 19%, 20%, or any range composed of any two of these values. By controlling the values of W2 and W3 to be within the ranges of this application, the mass percentage of the binder and the mass percentage of the conductive agent are within the proper ranges, allowing the inorganic metal oxide to have a proper mass percentage, which facilitates effective protection of the positive electrode current collector. Additionally, it enables good adhesion between the inorganic metal oxide and the positive electrode current collector, providing the positive electrode plate with relatively high electron conductivity, thereby improving the safety performance of the secondary battery while ensuring the cycling stability of the secondary battery.

In one embodiment of this application, the binder includes a polymer formed by monomers of at least one acrylic acid, acrylamide, lithium acrylate, sodium acrylate, acrylonitrile, methyl acrylate, ethyl acrylate, methyl 2-methacrylate, or ethyl 2-methacrylate. By selecting the above binders, the inorganic metal oxide can adhere well to the positive electrode current collector, providing the positive electrode plate with relatively high electron conductivity, which is beneficial to improving the cycling performance of the secondary battery.

In one embodiment of this application, the binder includes at least one of sodium carboxymethyl cellulose, potassium carboxymethyl cellulose, or nitrile rubber. By selecting the above binders, the inorganic metal oxide can adhere well to the positive electrode current collector, providing the positive electrode plate with relatively high electron conductivity, which is beneficial to improving the cycling performance of the secondary battery.

In one embodiment of this application, the weight-average molecular weight of the binder is from 150,000 to 1,950,000. Exemplarily, the weight-average molecular weight of the binder may be 150,000, 160,000, 350,000, 550,000, 750,000, 950,000, 1,150,000, 1,350,000, 1,550,000, 1,750,000, 1,950,000, or any range composed of any two of these values. By controlling the weight-average molecular weight of the binder within the range of this application, the film-forming property and adhesion of the undercoating layer can be balanced, improving the uniformity and stability of the undercoating layer, and effectively inhibiting corrosion of the positive electrode current collector by acidic substances, thereby improving the safety performance of the secondary battery while ensuring the cycling stability of the secondary battery.

In one embodiment of this application, the conductive agent includes at least one of graphene, graphite fibers, carbon nanotubes, or conductive carbon black. By selecting the above conductive agents, the positive electrode plate can have relatively high electron conductivity, which is beneficial to improving the cycling performance of the secondary battery.

In this application, the carbon nanotubes may include, but are not limited to, single-walled carbon nanotubes and/or multi-walled carbon nanotubes; and the conductive carbon black may include, but is not limited to, at least one of acetylene black or Ketjen black.

In one embodiment of this application, the negative electrode plate includes a negative electrode active material, where the negative electrode active material includes at least one of natural graphite, artificial graphite, mesocarbon microbeads, hard carbon, soft carbon, silicon, or silicon-based composite materials. With the negative electrode plate including the above negative electrode active materials, the secondary battery exhibits relatively high cycling stability and good safety performance. In this application, the silicon-based composite material may include SiO.

There is no particular restriction on the preparation method of the positive electrode plate in this application, as long as it achieves the purpose of this application. Exemplarily, the preparation method of the positive electrode plate may include the following steps: mixing the inorganic metal oxide, binder, and conductive agent in a certain ratio, adding a solvent, and mixing them well to obtain an inorganic slurry; and uniformly applying the inorganic slurry to one side surface of the positive electrode current collector, and drying it to obtain a positive electrode plate coated with an undercoating layer on one surface; mixing the positive electrode active material, positive electrode binder, and positive electrode conductive agent in a certain ratio, adding a solvent, mixing them well to obtain a positive electrode slurry, uniformly applying the positive electrode slurry to the undercoating layer, and drying it to obtain a positive electrode plate coated with the undercoating layer and positive electrode active material layer on one surface. The above steps are repeated on the other side surface of the positive electrode current collector to obtain a positive electrode plate. There is no particular restriction on the solvent in this application, as long as it achieves the purpose of this application, for example, the solvent may be N-methylpyrrolidone (NMP). There is no particular restriction on the solid content of the inorganic slurry in this application, as long as it achieves the purpose of this application, for example, the solid content of the inorganic slurry may be 20 wt % to 50 wt %. There is no particular restriction on the solid content of the positive electrode slurry in this application, as long as it achieves the purpose of this application, for example, the solid content of the positive electrode slurry may be 60 wt % to 80 wt %.

In this application, the positive electrode plate includes a positive electrode current collector, and an undercoating layer and a positive electrode active material layer that are disposed on at least one surface of the positive electrode current collector. The phrase “an undercoating layer and a positive electrode active material layer that are disposed on at least one surface of the positive electrode current collector” means that the undercoating layer and the positive electrode active material layer may be disposed on one surface of the positive electrode current collector along its thickness direction or on both surfaces of the positive electrode current collector along its thickness direction. It should be noted that the “surface” here may refer to the entire region of the positive electrode current collector or a partial region of the positive electrode current collector, and there is no particular restriction in this application, as long as it achieves the purpose of this application. There is no particular restriction on the positive electrode current collector in this application, as long as it achieves the purpose of this application, for example, it may include aluminum foil, aluminum alloy foil, or a composite current collector (for example, an aluminum-carbon composite current collector).

The positive electrode active material layer of this application includes a positive electrode active material. There is no particular restriction on the positive electrode active material in this application, as long as it achieves the purpose of this application, for example, the positive electrode active material may include at least one of lithium nickel cobalt manganese oxide (for example, common NCM811, NCM622, NCM523, NCM111), lithium nickel cobalt aluminate, lithium iron phosphate, lithium-rich manganese-based materials, lithium cobalt oxide (LiCoO₂), lithium manganese oxide, lithium manganese iron phosphate, or lithium titanate. The positive electrode active material layer of this application also includes a positive electrode conductive agent and a positive electrode binder. There is no particular restriction on the type of the positive electrode conductive agent in this application, as long as it achieves the purpose of this application, for example, the positive electrode conductive agent may include, but is not limited to, at least one of conductive carbon black (Super P), carbon nanotubes (CNTs), carbon fibers, flake graphite, graphene, metal materials, or conductive polymers. The conductive carbon black may include, but is not limited to, at least one of acetylene black or Ketjen black. The carbon nanotubes may include, but are not limited to, single-walled carbon nanotubes and/or multi-walled carbon nanotubes. The carbon fibers may include, but are not limited to, vapor-grown carbon fibers (VGCF) and/or nano-carbon fibers. The metal materials may include, but are not limited to, metal powders and/or metal fibers, specifically, the metal may include, but is not limited to, at least one of copper, nickel, aluminum, or silver. The conductive polymers may include, but are not limited to, at least one of polyphenylene derivatives, polyaniline, polythiophene, polyacetylene, or polypyrrole. There is no particular restriction on the positive electrode binder in this application, as long as it achieves the purpose of this application, for example, the positive electrode binder may include, but is not limited to, at least one of polyacrylate, polyimide, polyamide, polyamide-imide, polyvinylidene fluoride (PVDF), polystyrene-butadiene copolymer (styrene-butadiene rubber), sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose. There is no particular restriction on the mass ratio of the positive electrode active material, positive electrode conductive agent, and positive electrode binder in the positive electrode active material layer in this application, and those skilled in the art can select according to actual needs, as long as it achieves the purpose of this application.

There is no particular restriction on the thickness of the positive electrode current collector in this application, as long as it achieves the purpose of this application, for example, the thickness of the positive electrode current collector may be 5 μm to 20 μm. There is no particular restriction on the thickness of the positive electrode active material layer in this application, as long as it achieves the purpose of this application, for example, the thickness of the positive electrode active material layer before cold pressing may be 30 μm to 250 μm, and the thickness of the positive electrode active material layer after cold pressing may be 15 μm to 150 μm. There is no particular restriction on the thickness of the positive electrode plate in this application, as long as it achieves the purpose of this application, for example, the thickness of the positive electrode plate may be 50 μm to 500 μm.

In this application, the electrolyte further includes a lithium salt and a non-aqueous solvent. The lithium salt may include various lithium salts commonly used in the art, such as at least one of LiPF₆, LiBF₄, LiAsF₆, LiClO₄, LiB(C₆H₅)₄, LiCH₃SO₃, LiCF₃SO₃, LIN (SO₂CF₃)₂, LiC(SO₂CF₃)₃, Li₂SiF₆, lithium bis(oxalato) borate (LiBOB), or lithium difluoro (oxalato) borate. There is no particular restriction on the non-aqueous solvent in this application, as long as it achieves the purpose of this application, for example, it may include, but is not limited to, at least one of carbonate compounds, carboxylate compounds, ether compounds, or other organic solvents. The carbonate compounds may include, but are not limited to, at least one of linear carbonate compounds, cyclic carbonate compounds, or fluorinated carbonate compounds. The linear carbonate compounds may include, but are not limited to, at least one of dimethyl carbonate (DMC), diethyl carbonate (DEC), dipropyl carbonate (DPC), methyl propyl carbonate (MPC), ethyl propyl carbonate (EPC), or ethyl methyl carbonate (EMC). The cyclic carbonate compounds may include, but are not limited to, at least one of ethylene carbonate (EC), propylene carbonate (PC), butylene carbonate (BC), or vinyl ethylene carbonate (VEC). The fluorinated carbonate compounds may include, but are not limited to, at least one of 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compounds may include, but are not limited to, at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compounds may include, but are not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. There is no particular restriction on the mass percentages of the lithium salt and the non-aqueous solvent in this application, as long as it achieves the purpose of this application, for example, based on the mass of the electrolyte, the mass percentage of the lithium salt may be 10% to 30%, and the mass percentage of the non-aqueous solvent may be 49% to 89%.

In this application, the negative electrode plate includes a negative electrode current collector and a negative electrode active material layer disposed on at least one surface of the negative electrode current collector. The phrase “a negative electrode active material layer disposed on at least one surface of the negative electrode current collector” means that the negative electrode active material layer may be disposed on one surface of the negative electrode current collector along its thickness direction or on both surfaces of the negative electrode current collector along its thickness direction. It should be noted that the “surface” here may refer to the entire region of the negative electrode current collector or a partial region of the negative electrode current collector, and there is no particular restriction in this application, as long as it achieves the purpose of this application. There is no particular restriction on the negative electrode current collector in this application, as long as it achieves the purpose of this application, for example, it may include copper foil, copper alloy foil, nickel foil, stainless steel foil, titanium foil, nickel foam, copper foam, or a composite current collector.

The negative electrode active material layer of this application includes a negative electrode active material. The negative electrode active material layer of this application also includes a negative electrode binder. There is no particular restriction on the negative electrode binder in this application, as long as it achieves the purpose of this application, for example, the negative electrode binder may be at least one of the positive electrode binders described above. The negative electrode active material layer of this application also includes a negative electrode conductive agent. There is no particular restriction on the negative electrode conductive agent in this application, as long as it achieves the purpose of this application, for example, the negative electrode conductive agent may be at least one of the positive electrode conductive agents described above. There is no particular restriction on the mass ratio of the negative electrode active material, negative electrode binder, and negative electrode conductive agent in the negative electrode active material layer in this application, and those skilled in the art can select according to actual needs, as long as it achieves the purpose of this application.

There is no particular restriction on the thickness of the negative electrode current collector in this application, as long as it achieves the purpose of this application, for example, the thickness of the negative electrode current collector may be 5 μm to 15 μm. There is no particular restriction on the thickness of the negative electrode active material layer in this application, as long as it achieves the purpose of this application, for example, the thickness of the negative electrode active material layer before cold pressing may be 30 μm to 250 μm, and the thickness of the negative electrode active material layer after cold pressing may be 15 μm to 150 μm. There is no particular restriction on the thickness of the negative electrode plate in this application, as long as it achieves the purpose of this application, for example, the thickness of the negative electrode plate may be 50 μm to 500 μm.

In this application, the secondary battery further includes a separator. The separator is used to separate the positive electrode plate and the negative electrode plate, preventing short circuits in the secondary battery, allowing electrolyte ions to pass freely, and not affecting the electrochemical charge-discharge process. There is no particular restriction on the separator in this application, as long as it achieves the purpose of this application. For example, the material of the separator may include, but is not limited to, at least one of polyolefin (PO) mainly composed of polyethylene (PE) or polypropylene (PP), polyester (for example, polyethylene terephthalate (PET) film), cellulose, polyimide (PI), polyamide (PA), spandex, or aramid; and the type of separator may include at least one of woven films, non-woven films, microporous films, composite films, rolled films, or spun films.

In this application, the separator may include a substrate and a surface treatment layer. The substrate may be a non-woven fabric or composite film with a porous structure, and the material of the substrate may include at least one of polyethylene, polypropylene, polyethylene terephthalate, or polyimide. Optionally, a polypropylene porous film, polyethylene porous film, polypropylene non-woven fabric, polyethylene non-woven fabric, or polypropylene-polyethylene-polypropylene porous composite film may be used. Optionally, a surface treatment layer is disposed on at least one surface of the substrate, and the surface treatment layer may be a polymer layer or an inorganic layer, or a layer formed by mixing a polymer and an inorganic material. For example, the inorganic layer includes inorganic particles and a separator binder, and there is no particular restriction on the inorganic particles in this application, for example, they may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. There is no particular restriction on the separator binder in this application, for example, it may be at least one of the positive electrode binders described above. The polymer layer includes a polymer, and the material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

The secondary battery of this application also includes a packaging bag for accommodating the positive electrode plate, separator, negative electrode plate, and electrolyte, as well as other components known in the art in the secondary battery, and this application does not limit these other components. There is no particular restriction on the packaging bag in this application, and it may be a packaging bag known in the art, as long as it achieves the purpose of this application.

In this application, the secondary battery may include, but is not limited to, lithium metal secondary batteries, lithium-ion secondary batteries (lithium-ion batteries), lithium polymer secondary batteries, or lithium-ion polymer secondary batteries.

The preparation process of the secondary battery of this application is well known to those skilled in the art, and there is no particular restriction in this application, for example, it may include, but is not limited to, the following steps: stacking the positive electrode plate, separator, and negative electrode plate in order, and performing operations such as winding or folding as needed to obtain an electrode assembly as a jelly-roll structure, placing the electrode assembly into a packaging bag, injecting the electrolyte into the packaging bag, and sealing it to obtain a secondary battery; alternatively, stacking the positive electrode plate, separator, and negative electrode plate in order, fixing the four corners of the entire stacked structure with tape to obtain an electrode assembly with a laminated structure, placing the electrode assembly into a packaging bag, injecting the electrolyte into the packaging bag, and sealing it to obtain a secondary battery. Additionally, overcurrent protection elements, guide plates, and the like may be placed in the packaging bag as needed to prevent pressure rise and overcharge-discharge inside the secondary battery. The packaging bag is a packaging bag known in the art, and this application does not limit it.

A second aspect of this application provides an electronic device including the secondary battery according to any one of the above embodiments. Therefore, the electronic device provided by this application exhibits good usage performance.

There is no particular restriction on the type of electronic device in this application, and it may be any electronic device known in the prior art. In some embodiments, the electronic device may include, but is not limited to, notebook computers, pen-input computers, mobile computers, e-book readers, portable phones, portable fax machines, portable copiers, portable printers, headsets, video recorders, LCD TVs, handheld cleaners, portable CD players, mini discs, transceivers, electronic organizers, calculators, memory cards, portable recorders, radios, backup power supplies, motors, automobiles, motorcycles, electric bicycles, bicycles, lighting fixtures, toys, gaming consoles, clocks, power tools, flashlights, cameras, large household batteries, and lithium-ion capacitors.

### EXAMPLES

The following examples and comparative examples are provided to more specifically illustrate some embodiments of this application. Various tests and evaluations were conducted according to the methods described below. Unless otherwise specified, “parts” and “%” are based on mass.

Test methods and equipment:

Test for element type and content and mass percentage of inorganic metal oxide:

A lithium-ion battery was disassembled, a positive electrode plate was separated, a positive electrode active material layer on the surface of the positive electrode plate was peeled off with tape to expose an undercoating layer, and the undercoating layer was scraped off the positive electrode plate with a knife to obtain a solid powder sample. An inductively coupled plasma optical emission spectrometer (ICP-OES) was used to detect the types and contents of elements in the solid powder sample. 0.2 g of the solid powder sample was weighed and dissolved in a 42% nitric acid solution, and the nitric acid solution containing the dissolved solid powder sample was tested to obtain the types and contents of elements in the solid powder sample. The mass percentage of the corresponding inorganic metal oxide was calculated based on the types and contents of the metal elements.

Test for mass percentage of first compound:

Gas chromatography was used to test the mass percentage of the first compound. After the lithium-ion battery was discharged to 3 V, a packaging bag at a tab of the lithium-ion battery was cut open, the lithium-ion battery with the opening downward was placed into a centrifuge tube for centrifugation to obtain an electrolyte, and gas chromatography was used to test the mass percentage of the first compound in the centrifuged electrolyte.

Weight-average molecular weight test:

A gel chromatograph was used to test a weight-average molecular weight of a binder. 0.01 g of the binder was dissolved in 5 mL of a solvent (N-methylpyrrolidone) to obtain a solution, until the solution was completely dissolved, impurities in the solution were filtered out with a filter head, and then the gel chromatograph (model PL-GPC220) was used to test the weight-average molecular weight of the binder.

Cycling performance test:

At 45° C., the lithium-ion battery was charged at a constant current of 0.5C to 4.3 V, left standing for 30 min, and then discharged at a constant current of 0.5C to 3.0 V. This constituted one charge-discharge cycle. The first discharge capacity was recorded as C₁. 200 charge-discharge cycles were performed as described above and the discharge capacity after the 200th cycle was recorded as C200.

Cycling capacity retention rate of the lithium-ion battery=(C₂₀₀/C₁)×100%.

Drop test:

The lithium-ion battery after 200 cycles at 45° C. was taken (at this time, the lithium-ion battery was discharged to 3.0 V), charged at a constant current of 0.5C to 4.45 V at 25° C., and charged at a constant voltage of 4.45 V to a current of 0.025C. In a test environment of 20±5° C., the concrete floor was used as the drop surface, the battery was dropped from a height of 2 m (with the concrete floor as the reference) along three faces of the lithium-ion battery once each, three edges once each, and eight corners once each, for a total of one round of testing. The drop sequence was: three faces once each, three edges once each, and eight corners once each. If the lithium-ion battery under test did not smoke, leak, catch fire, or explode, it was considered to have passed. 50 lithium-ion batteries per group were tested. The lithium-ion battery was a pouch lithium-ion battery, rectangular in shape, including six faces, namely, a top face, a bottom face, a left face, a right face, a front face, and a back face, where the three faces referred to one each of the top-bottom, left-right, and front-back faces. The battery included twelve edges, namely, four long edges, four wide edges, and four high edges, where the three edges referred to one each of the long, wide, and high edges.

### Example 1-1

### Preparation of Positive Electrode Plate

An inorganic metal oxide TiO₂, a binder nitrile rubber, and a conductive agent carbon nanotubes were mixed in a mass ratio of 58:22:20, and then N-methylpyrrolidone (NMP) as a solvent was added and stirred well under the action of a vacuum mixer to obtain an inorganic slurry with a solid content of 30 wt %. The inorganic slurry was uniformly applied to one side surface of a positive electrode current collector aluminum foil with a thickness of 12 μm, and the aluminum foil was dried at 90° C. for 1 h to obtain a positive electrode plate coated on one surface with the undercoating layer, the undercoating layer having a thickness of 2.15 μm. The undercoating layer included the inorganic metal oxide TiO₂, where the inorganic metal oxide TiO₂ included an element M, and the element M was Ti. A positive electrode active material lithium cobalt oxide (molecular formula LiCoO₂), a positive electrode binder polyvinylidene fluoride (PVDF), and a positive electrode conductive agent conductive carbon black (Super P) were mixed in a mass ratio of 96:2:2, and the solvent N-methylpyrrolidone (NMP) was added and stirred well under the action of a vacuum mixer to obtain a positive electrode slurry with a solid content of 70 wt %. The positive electrode slurry was uniformly applied to the surface of the undercoating layer and dried at 120° C. for 1 h to obtain a positive electrode plate coated on one surface with the undercoating layer and a positive electrode active material layer (with a thickness of 230 μm). Then the above steps were repeated on the other side surface of the aluminum foil to obtain a positive electrode plate coated on two surfaces with the undercoating layer and the positive electrode active material layer. After cold pressing and slitting, a positive electrode plate with specifications of 74 mm×867 mm was obtained. The thickness of the positive electrode active material layer after cold pressing was 102 μm.

### Preparation of Negative Electrode Plate

A negative electrode active material, a negative electrode binder sodium carboxymethyl cellulose (CMC-Na), and a negative electrode binder styrene-butadiene rubber were mixed in a mass ratio of 85:2:13, and deionized water was added and mixed well under the action of a vacuum mixer to obtain a negative electrode slurry with a solid content of 30 wt %. The negative electrode slurry was uniformly applied to one side surface of a negative electrode current collector copper foil with a thickness of 12 μm and dried at 120° C. for 1 h to obtain a negative electrode plate coated on one surface with a negative electrode active material layer having a coating thickness of 143 μm, and the above steps were repeated on the other side surface of the copper foil to obtain a negative electrode plate coated with the negative electrode active material layer on two surfaces. After cold pressing and slitting, a negative electrode plate with specifications of 78 mm×875 mm was obtained. The negative electrode active material was a mixture of SiO and artificial graphite, with a mass ratio of SiO to artificial graphite of 20:80 based on the mass of the negative electrode active material. The thickness of the negative electrode active material layer on one surface after cold pressing was 80 μm.

### Preparation of Separator

A porous polypropylene film with a thickness of 12 μm (provided by Celgard) was used.

### Preparation of Electrolyte

In an argon atmosphere glovebox with a water content of less than 10 ppm, ethylene carbonate and diethyl carbonate were mixed in a mass ratio of 3:7 to obtain an organic solvent, and then a lithium salt LiPF₆ and the first compound fluorinated ethylene carbonate were added to the organic solvent and stirred well to obtain an electrolyte. Based on the total mass of the electrolyte, the mass percentage a % of the first compound was 0.15%, the mass percentage of the lithium salt was 13%, and the balance was the organic solvent.

### Preparation of Lithium-Ion Battery

The positive electrode plate, a separator, and the negative electrode plate were stacked in order, with the separator positioned between the positive electrode plate and the negative electrode plate to isolate the positive electrode plate and the negative electrode plate, and then were wound. A positive electrode tab was connected to the positive electrode plate and a negative electrode tab was connected to the negative electrode plate to obtain an electrode assembly. The electrode assembly was placed into an internal space of an outer packaging, where the outer packaging was an aluminum foil packaging bag, and the positive electrode tab and negative electrode tab were led out of the internal space of the outer packaging to an external space of the outer packaging. After baking at 80° C. for 10 h to remove water, the electrolyte was injected into the internal space of the outer packaging, and processes such as vacuum sealing, standing, formation, and shaping were performed to obtain the lithium-ion battery.

### Example 1-2 to Example 1-26

Except for relevant preparation parameters being adjusted according to Table 1, the rest was the same as in Example 1-1. As the mass percentage W1 of the inorganic metal oxide changed, the sum of the mass percentages of the binder and the conductive agent changed accordingly, and the mass ratio of the binder to the conductive agent remained unchanged. When the mass percentage of the added first compound changed, the mass percentage of the organic solvent changed accordingly, while the mass ratio of ethylene carbonate to diethyl carbonate and the mass percentage of the lithium salt remained unchanged.

### Example 1-27

Except that in the <preparation of negative electrode plate>, the negative electrode active material was artificial graphite, the rest was the same as in Example 1-1.

### Example 2-1 to Example 2-12

Except for relevant preparation parameters being adjusted according to Table 2, the rest was the same as in Example 1-5. When the mass percentage of the added first compound changed, the mass percentage of the organic solvent changed accordingly, while the mass ratio of ethylene carbonate to diethyl carbonate and the mass percentage of the lithium salt remained unchanged.

### Example 3-1 to Example 3-20

Except for relevant preparation parameters being adjusted according to Table 3, the rest was the same as in Example 2-3. As the mass percentage W2 of the binder and the mass percentage W3 of the conductive agent changed, the mass percentage W1 of the inorganic metal oxide changed accordingly.

### Comparative Example 1

Except for the positive electrode plate being prepared according to the following method and relevant preparation parameters being adjusted according to Table 1, the rest was the same as in Example 1-1.

### Preparation of Positive Electrode Plate

A positive electrode active material lithium cobalt oxide (with a molecular formula LiCoO₂), a positive electrode binder polyvinylidene fluoride (PVDF), and a positive electrode conductive agent conductive carbon black (Super P) were mixed in a mass ratio of 96:2:2, and a solvent N-methylpyrrolidone (NMP) was added and stirred well under the action of a vacuum mixer to obtain a positive electrode slurry with a solid content of 70 wt %. The positive electrode slurry was uniformly applied to one side surface of a positive electrode current collector aluminum foil with a thickness of 12 μm, and dried at 120° C. for 1 h to obtain a positive electrode plate coated on one surface with a positive electrode active material layer having a coating thickness of 227.8 μm, and the above steps were repeated on the other side surface of the aluminum foil to obtain a positive electrode plate coated with the positive electrode active material layer on two surfaces. After cold pressing and slitting, a positive electrode plate with specifications of 74 mm×867 mm was obtained. The thickness of the positive electrode active material layer after cold pressing was 102 μm.

### Comparative Example 2 to Comparative Example 5

Except for relevant preparation parameters being adjusted according to Table 1, the rest was the same as in Example 1-1. As the mass percentage W1 of the inorganic metal oxide changed, the sum of the mass percentages of the binder and the conductive agent changed accordingly, and the mass ratio of the binder to the conductive agent remained unchanged. When the mass percentage of the added first compound changed, the mass percentage of the organic solvent changed accordingly, while the mass ratio of ethylene carbonate to diethyl carbonate and the mass percentage of the lithium salt remained unchanged.

The preparation parameters and electrical performance parameters of each example and comparative example are shown in Tables 1 to 3.

TABLE 1

| | | | | | | Cycling | Drop test |
|---|---|---|---|---|---|---|---|
| | | | | | | capacity | pass |
| | | | Inorganic | | | retention | number |
| | First compound | a (%) | metal oxide | Element M | W1 (%) | rate (%) | (units) |
| Example 1-1 | Fluorinated ethylene | 0.15 | TiO₂ | Ti | 58 | 50 | 15/50 |
| | carbonate | | | | | | |
| Example 1-2 | Fluorinated ethylene | 0.5 | TiO₂ | Ti | 58 | 52 | 14/50 |
| | carbonate | | | | | | |
| Example 1-3 | Fluorinated ethylene | 1 | TiO₂ | Ti | 58 | 55 | 14/50 |
| | carbonate | | | | | | |
| Example 1-4 | Fluorinated ethylene | 3 | TiO₂ | Ti | 58 | 58 | 13/50 |
| | carbonate | | | | | | |
| Example 1-5 | Fluorinated ethylene | 5 | TiO₂ | Ti | 58 | 63 | 12/50 |
| | carbonate | | | | | | |
| Example 1-6 | Fluorinated ethylene | 10 | TiO₂ | Ti | 58 | 69 | 11/50 |
| | carbonate | | | | | | |
| Example 1-7 | Fluorinated ethylene | 12 | TiO₂ | Ti | 58 | 70 | 10/50 |
| | carbonate | | | | | | |
| Example 1-8 | Fluorinated ethylene | 21 | TiO₂ | Ti | 58 | 60 | 10/50 |
| | carbonate | | | | | | |
| Example 1-9 | Fluorinated ethylene | 5 | TiO₂ | Ti | 55 | 63 | 11/50 |
| | carbonate | | | | | | |
| Example 1-10 | Fluorinated ethylene | 5 | TiO₂ | Ti | 60 | 63 | 16/50 |
| | carbonate | | | | | | |
| Example 1-11 | Fluorinated ethylene | 5 | TiO₂ | Ti | 70 | 63 | 17/50 |
| | carbonate | | | | | | |
| Example 1-12 | Fluorinated ethylene | 5 | TiO₂ | Ti | 75 | 63 | 20/50 |
| | carbonate | | | | | | |
| Example 1-13 | Fluorinated ethylene | 5 | TiO₂ | Ti | 85 | 63 | 25/50 |
| | carbonate | | | | | | |
| Example 1-14 | Fluorinated ethylene | 5 | TiO₂ | Ti | 95 | 63 | 15/50 |
| | carbonate | | | | | | |
| Example 1-15 | Fluorinated ethylene | 5 | TiO₂ | Ti | 99 | 63 | 15/50 |
| | carbonate | | | | | | |
| Example 1-16 | Fluorinated ethylene | 5 + 1 | TiO₂ | Ti | 58 | 65 | 15/50 |
| | carbonate + ethylene | | | | | | |
| | sulfate | | | | | | |
| Example 1-17 | Fluorinated ethylene | 2 + 3 | TiO₂ | Ti | 58 | 65 | 14/50 |
| | carbonate + succinic | | | | | | |
| | anhydride | | | | | | |
| Example 1-18 | Glutaric anhydride + | 2 + 4 | TiO₂ | Ti | 58 | 66 | 15/50 |
| | succinic anhydride | | | | | | |
| Example 1-19 | Ethylene sulfate + | 4 + 1 | TiO₂ | Ti | 58 | 65 | 13/50 |
| | succinic anhydride | | | | | | |
| Example 1-20 | Fluorinated ethylene | 1 + 1 + 1 | TiO₂ | Ti | 58 | 65 | 15/50 |
| | carbonate + ethylene | | | | | | |
| | sulfate + succinic | | | | | | |
| | anhydride | | | | | | |
| Example 1-21 | Fluorinated ethylene | 5 | TiO₂ + | Ti + A1 | 32 + 35 | 63 | 17/50 |
| | carbonate | | Al₂O₃ | | | | |
| Example 1-22 | Fluorinated ethylene | 5 | TiO₂ + | Ti + Sn | 45 + 20 | 63 | 21/50 |
| | carbonate | | SnO₂ | | | | |
| Example 1-23 | Fluorinated ethylene | 5 | Al₂O₃ + | A1 + Sn | 50 + 10 | 63 | 17/50 |
| | carbonate | | SnO₂ | | | | |
| Example 1-24 | Fluorinated ethylene | 5 | TiO₂ + | Ti + Al + | 60 + 20 + 5 | 63 | 24/50 |
| | carbonate | | Al₂O₃ + | Sb | | | |
| | | | Sb₂O₃ | | | | |
| Example 1-25 | Fluorinated ethylene | 5 + 1 + 1 | TiO₂ + | Ti + Al + | 50 + 23 + 10 | 66 | 26/50 |
| | carbonate + ethylene | | Al₂O₃ + | Sb | | | |
| | sulfate + succinic | | Sb₂O₃ | | | | |
| | anhydride | | | | | | |
| Example 1-26 | Fluorinated ethylene | 5 | MgO | Mg | 58 | 65 | 16/50 |
| | carbonate | | | | | | |
| Example 1-27 | Fluorinated ethylene | 0.15 | TiO₂ | Ti | 58 | 65 | 17/50 |
| | carbonate | | | | | | |
| Comparative | Fluorinated ethylene | 5 | / | / | / | 62 | 2/50 |
| Example 1 | carbonate | | | | | | |
| Comparative | Fluorinated ethylene | 5 | TiO₂ | Ti | 50 | 63 | 3/50 |
| Example 2 | carbonate | | | | | | |
| Comparative | Fluorinated ethylene | 0.1 | TiO₂ | Ti | 58 | 43 | 15/50 |
| Example 3 | carbonate | | | | | | |
| Comparative | Fluorinated ethylene | 22 | TiO₂ | Ti | 58 | 60 | 6/50 |
| Example 4 | carbonate | | | | | | |
| Comparative | Fluorinated ethylene | 5 | TiO₂ | Ti | 99.3 | 63 | 6/50 |
| Example 5 | carbonate | | | | | | |

Note:
(1) In Table 1, “/” indicates no relevant preparation parameters.
(2) Taking Example 1-16 as an example, the first compound in Table 1 is “fluorinated ethylene carbonate + ethylene sulfate,” and the mass percentage a % of the first compound is “5% + 1%,” meaning that the added first compounds are fluorinated ethylene carbonate and ethylene sulfate, with a mass percentage of 5% for fluorinated ethylene carbonate and a mass percentage of 1% for ethylene sulfate based on the mass of the electrolyte; other examples and comparative examples are understood similarly.
(3) Taking Example 1-21 as an example, the inorganic metal oxide in Table 1 is “TiO₂ + Al₂O₃,” element M is “Ti + Al,” and the mass percentage W1 of the inorganic metal oxide is “32% + 35%,” meaning that two inorganic metal oxides, TiO₂ and Al₂O₃ , are added to the undercoating layer, element M includes Ti and Al, and based on the mass of the undercoating layer, the mass percentage of inorganic metal oxide TiO₂ is 32%, and the mass percentage of inorganic metal oxide Al₂O₃ is 35%; other examples and comparative examples are understood similarly.
(4) Taking Example 1-1 as an example, the drop test pass number in Table 1 is “15/50,” indicating that 50 lithium-ion batteries were tested, of which 15 lithium-ion batteries did not smoke, leak, catch fire, or explode, which means 15 lithium-ion batteries passed the drop test; other examples and comparative examples are understood similarly.

Referring to Table 1, from Example 1-1 to Example 1-27 and Comparative Example 1 to Comparative Example 5, it can be seen that when the undercoating layer of the positive electrode plate includes an inorganic metal oxide, and the mass percentage of the inorganic metal oxide, the type of element included in the inorganic metal oxide, and the type and mass percentage of the first compound in the electrolyte are within the ranges of this application, the lithium-ion battery has a relatively high cycling capacity retention rate and a relatively large number of drop test passes, indicating good cycling stability of the lithium-ion battery and good safety performance of the lithium-ion battery. In contrast, in Comparative Example 1 to Comparative Example 5, the lithium-ion battery has a relatively low cycling capacity retention rate and a relatively small number of drop test passes, indicating relatively poor cycling stability and relatively poor safety performance of the lithium-ion battery.

In Example 1-1 to Example 1-8, by adjusting the mass percentage of the first compound, the cycling stability of the lithium-ion battery can be improved within a certain range, and when the mass percentage of the first compound is relatively low, the number of drop test passes is relatively large, indicating a relatively significant improvement in the safety performance of the lithium-ion battery. As the mass percentage of the first compound increases, the improvement in the safety performance of the lithium-ion battery decreases. When the mass percentage of the first compound is 0.5% to 12%, a relatively stable solid electrolyte interface film can be formed on the surface of the negative electrode plate, while producing a relatively small amount of acidic substances, which have a relatively small impact on the aluminum foil, resulting in relatively high cycling stability and good safety performance of the lithium-ion battery.

In Example 1-9 to Example 1-15, when the mass percentage of the inorganic metal oxide in the undercoating layer is within the range of this application, the number of drop test passes is relatively large, indicating improved safety performance of the lithium-ion battery. An increase in the mass percentage of the inorganic metal oxide in the undercoating layer can reduce direct contact between the electrolyte and the aluminum foil, and allows the inorganic metal oxide to fully react with the acidic substances produced by the first compound, enhancing the strength of the aluminum foil, and enabling the lithium-ion battery to maintain relatively strong impact resistance during the drop test. When the mass percentage of the inorganic metal oxide is 60% to 85%, the improvement in safety performance is relatively significant.

In Example 1-16 to Example 1-25, by adding multiple types of first compounds or multiple inorganic metal oxides to the undercoating layer, the lithium-ion battery has a relatively high cycling capacity retention rate and a relatively large number of drop test passes, indicating that both the cycling stability and safety performance of the lithium-ion battery can be improved simultaneously. In Comparative Example 1, the positive electrode plate does not include an undercoating layer, and due to the presence of the first compound, acidic substances produced during the cycling of the lithium-ion battery easily corrode the aluminum foil and the positive electrode active material, resulting in relatively poor safety performance of the lithium-ion battery. From Comparative Example 2 and Comparative Example 5, it can be seen that when the mass percentage of the inorganic metal oxide in the undercoating layer is too low, the safety performance of the lithium-ion battery is relatively poor; when the mass percentage of the inorganic metal oxide in the undercoating layer is too high, it does not further improve the safety performance of the lithium-ion battery. From Comparative Example 3 and Comparative Example 4, it can be seen that when the mass percentage of the first compound is too low, the cycling stability of the lithium-ion battery is relatively poor, as the too low content of the first compound makes it difficult to form a stable solid electrolyte interface film on the surface of the negative electrode plate, and the instability of the negative electrode plate is detrimental to the cycling stability of the lithium-ion battery; when the mass percentage of the first compound is too high, it does not further improve the cycling stability of the lithium-ion battery and leads to relatively poor safety performance of the lithium-ion battery.

TABLE 2

| | | | | Cycling | |
|---|---|---|---|---|---|
| | | | | capacity | |
| | A | | | retention rate | Drop test pass |
| | (μm) | a (%) | a/A | (%) | number (units) |
| Example 1-5 | 2.15 | 5 | 2.32 | 63 | 12/50 |
| Example 2-1 | 2 | 5 | 2.5 | 63 | 11/50 |
| Example 2-2 | 2.1 | 5 | 2.38 | 63 | 11/50 |
| Example 2-3 | 2.5 | 5 | 2 | 63 | 30/50 |
| Example 2-4 | 5 | 5 | 1 | 63 | 36/50 |
| Example 2-5 | 9.5 | 5 | 0.52 | 63 | 38/50 |
| Example 2-6 | 15 | 5 | 0.33 | 63 | 29/50 |
| Example 2-7 | 15.5 | 5 | 0.32 | 63 | 29/50 |
| Example 2-8 | 16 | 1 | 0.06 | 60 | 40/50 |
| Example 2-9 | 15 | 0.3 | 0.02 | 58 | 42/50 |
| Example 2-10 | 15 | 0.2 | 0.013 | 55 | 42/50 |
| Example 2-11 | 2 | 10.2 | 5.1 | 67 | 11/50 |
| Example 2-12 | 2 | 11 | 5.5 | 69 | 11/50 |

The thickness A of the undercoating layer typically affects the cycling stability, safety performance, and energy density of the lithium-ion battery. From Example 1-5, and Example 2-1 to Example 2-8, it can be seen that increasing the thickness of the undercoating layer can increase the number of drop test passes within a certain range, which is beneficial to improving the safety performance of the lithium-ion battery. When the thickness of the undercoating layer is 2.5 μm to 9.5 μm, the lithium-ion battery has good cycling stability and good safety performance. From Example 1-5, and Example 2-1 and Example 2-2, it can be seen that when the thickness of the undercoating layer is relatively small, the inhibition of corrosion of the aluminum foil by the first compound is relatively limited, resulting in limited improvement in the safety performance of the lithium-ion battery, but when the thickness of the undercoating layer is within the range of this application, the lithium-ion battery has better safety performance. From Example 2-6 to Example 2-8, it can be seen that when the thickness of the undercoating layer is relatively large, it does not further improve the cycling performance of the lithium-ion battery and affects the energy density of the lithium-ion battery.

The value of a/A typically affects the cycling stability and safety performance of the lithium-ion battery. From Example 2-1 to Example 2-12, it can be seen that by controlling the value of a/A within the range of this application, the lithium-ion battery has a relatively high cycling capacity retention rate and a relatively large number of drop test passes, indicating relatively high cycling stability of the lithium-ion battery and good safety performance of the lithium-ion battery.

TABLE 3

| | | | Weight- | | | | |
|---|---|---|---|---|---|---|---|
| | | | average | | | Cycling | Drop test |
| | | | molecular | | | capacity | pass |
| | | | weight of | Conductive | | retention | number |
| | Binder | W2 (%) | binder | agent | W3 (%) | rate (%) | (units) |
| Example 2-3 | Nitrile rubber | 22 | 160,000 | Carbon | 20 | 63 | 30/50 |
| | | | | nanotubes | | | |
| Example 3-1 | Nitrile rubber | 18 | 160,000 | Carbon | 20 | 63 | 31/50 |
| | | | | nanotubes | | | |
| Example 3-2 | Nitrile rubber | 17 | 160,000 | Carbon | 20 | 63 | 36/50 |
| | | | | nanotubes | | | |
| Example 3-3 | Nitrile rubber | 13 | 160,000 | Carbon | 20 | 63 | 42/50 |
| | | | | nanotubes | | | |
| Example 3-4 | Nitrile rubber | 10 | 160,000 | Carbon | 20 | 63 | 38/50 |
| | | | | nanotubes | | | |
| Example 3-5 | Nitrile rubber | 5 | 160,000 | Carbon | 20 | 63 | 39/50 |
| | | | | nanotubes | | | |
| Example 3-6 | Nitrile rubber | 1 | 160,000 | Carbon | 20 | 63 | 39/50 |
| | | | | nanotubes | | | |
| Example 3-7 | Nitrile rubber | 0.8 | 160,000 | Carbon | 20 | 63 | 32/50 |
| | | | | nanotubes | | | |
| Example 3-8 | Nitrile rubber | 0.5 | 160,000 | Carbon | 20 | 55 | 29/50 |
| | | | | nanotubes | | | |
| Example 3-9 | Nitrile rubber | 25 | 160,000 | Carbon | 20 | 56 | 29/50 |
| | | | | nanotubes | | | |
| Example 3-10 | Nitrile rubber | 20 | 160,000 | Carbon | 15 | 65 | 32/50 |
| | | | | nanotubes | | | |
| Example 3-11 | Nitrile rubber | 20 | 160,000 | Carbon | 14 | 65 | 36/50 |
| | | | | nanotubes | | | |
| Example 3-12 | Nitrile rubber | 20 | 160,000 | Carbon | 10 | 65 | 34/50 |
| | | | | nanotubes | | | |
| Example 3-13 | Nitrile rubber | 20 | 160,000 | Carbon | 5 | 66 | 35/50 |
| | | | | nanotubes | | | |
| Example 3-14 | Nitrile rubber | 20 | 160,000 | Carbon | 1 | 64 | 35/50 |
| | | | | nanotubes | | | |
| Example 3-15 | Nitrile rubber | 20 | 160,000 | Carbon | 0.5 | 64 | 35/50 |
| | | | | nanotubes | | | |
| Example 3-16 | Nitrile rubber | 20 | 160,000 | Carbon | 0.3 | 60 | 35/50 |
| | | | | nanotubes | | | |
| Example 3-17 | Nitrile rubber + | 15 + 5 | 160,000 + | Acetylene | 5 | 65 | 36/50 |
| | polyacrylamide | | 190,000 | black | | | |
| Example 3-18 | Polymethyl | 16 + 5 | 350,000 + | Graphite fibers | 5 | 65 | 38/50 |
| | acrylate + sodium | | 250,000 | | | | |
| | carboxymethyl | | | | | | |
| | cellulose | | | | | | |
| Example 3-19 | Nitrile rubber + | 4 + 10 | 160,000 + | Graphene + | 5 + 5 | 53 | 36/50 |
| | polyacrylamide | | 190,000 | acetylene black | | | |
| Example 3-20 | Polyacrylonitrile | 15 | 150,000 | Graphite fibers | 10 +2 | 65 | 37/50 |
| | | | | + acetylene | | | |
| | | | | black | | | |

Note:
(1) Taking Example 3-19 as an example, the binder in Table 3 is “nitrile rubber + polyacrylamide,” and the mass percentage W2 of the binder is “4% + 10%,” meaning that the added binders are nitrile rubber and polyacrylamide, with a mass percentage of 4% for nitrile rubber and a mass percentage of 10% for polyacrylamide based on the mass of the undercoating layer. The conductive agent in Table 3 is “graphene + acetylene black,” and the mass percentage W3 of the conductive agent is “5% + 5%,” meaning that the added conductive agents are graphene and acetylene black, with a mass percentage of 5% for graphene and a mass percentage of 5% for acetylene black based on the mass of the undercoating layer; other examples are understood similarly.
(2) Taking Example 3-17 as an example, the binder in Table 3 is “nitrile rubber + polyacrylamide,” and the weight-average molecular weight of the binder is “160,000 + 190,000,” meaning that the weight-average molecular weight of the nitrile rubber binder is 160,000, and the weight-average molecular weight of the polyacrylamide binder is 190,000; other examples are understood similarly.

The mass percentage W2 of the binder and the mass percentage W3 of the conductive agent typically affect the cycling stability and safety performance of the lithium-ion battery. From Example 3-1 to Example 3-16, it can be seen that by controlling the mass percentage W2 of the binder and the mass percentage W3 of the conductive agent to be within the ranges of this application, the lithium-ion battery has a relatively high cycling capacity retention rate and a relatively large number of drop test passes, indicating good cycling stability and safety performance of the lithium-ion battery. When the mass percentage of the conductive agent is relatively low, it affects the electron conductivity of the positive electrode plate, thereby affecting the cycling stability of the lithium-ion battery, but when the mass percentage of the conductive agent is within the range of this application, the lithium-ion battery has good cycling stability.

The type and weight-average molecular weight of the binder and the type of conductive agent typically also affect the cycling stability and safety performance of the lithium-ion battery. From Example 3-1 to Example 3-20, it can be seen that by selecting the above binder and controlling the weight-average molecular weight of the binder within the range of this application, as well as selecting the above conductive agent, the lithium-ion battery has a relatively high cycling capacity retention rate and a relatively large number of drop test passes, indicating good cycling stability and safety performance of the lithium-ion battery.

The above are only preferred embodiments of this application and are not intended to limit this application. Any modifications, equivalent substitutions, improvements, and the like made within the spirit and principles of this application should be included within the scope of protection of this application.

1. A secondary battery, comprising a positive electrode plate, a negative electrode plate, and an electrolyte; the positive electrode plate comprising a positive electrode current collector, and an undercoating layer and a positive electrode active material layer are disposed on at least one surface of the positive electrode current collector, wherein the undercoating layer is disposed between the positive electrode current collector and the positive electrode active material layer; and the undercoating layer comprises an inorganic metal oxide, the inorganic metal oxide comprising element M, and the element M comprising at least one of Al, Ti, Sn, Sb, or Mg; based on a mass of the undercoating layer, a mass percentage of the inorganic metal oxide is W1, wherein 55%≤W1≤99%; and
the electrolyte comprises a first compound; the first compound comprising at least one of fluorinated ethylene carbonate, difluorinated ethylene carbonate, a compound represented by formula (I), a compound represented by formula (II), or a compound represented by formula (III), 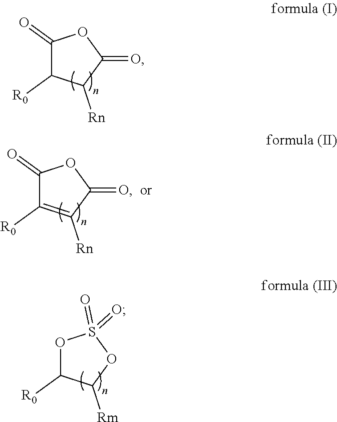
wherein n and m are independently selected from integers from 1 to 3, and R₀, Rn, and R^{m} are each independently selected from hydrogen, fluorine, a substituted or unsubstituted C1-C6 alkyl group, or a substituted or unsubstituted C2-C6 alkenyl group; and during substitution, a substituent of each group is a halogen; and
based on a mass of the electrolyte, a mass percentage of the first compound is a %, wherein 0.15≤a≤21.

2. The secondary battery according to claim 1, wherein the element M comprises at least one of Ti, Sn, or Sb.

3. The secondary battery according to claim 1, wherein the secondary battery satisfies at least one of the following characteristics:
$$0.5 \leq a \leq 12 ; or \qquad ( 1 )$$
$$60 \% \leq W 1 \leq 85 \% . \qquad ( 2 )$$

4. The secondary battery according to claim 1, wherein a thickness of the undercoating layer is A μm, wherein 2.1≤A≤15.5.

5. The secondary battery according to claim 1, wherein a thickness of the undercoating layer is A μm, wherein 2.5≤A≤9.5.

6. The secondary battery according to claim 4, wherein 0.02≤a/A≤5.1.

7. The secondary battery according to claim 1, wherein the compound represented by formula (I) comprises at least one of succinic anhydride, glutaric anhydride, or adipic anhydride; the compound represented by formula (II) comprises at least one of maleic anhydride, citraconic anhydride, trifluoromethyl maleic anhydride, dimethyl maleic anhydride, 3-fluorofuran-2,5-dione, or 3,4-difluoromaleic anhydride; and the compound represented by formula (III) comprises at least one of ethylene sulfate, propylene sulfate, butylene sulfate, 1,3,2-dioxathiane-2,2-dioxide, or 2-methyl-1,3-propane disulfonate.

8. The secondary battery according to claim 1, wherein the inorganic metal oxide comprises at least one of Al₂O₃, TiO₂, SnO₂, SnO, Sb₂O₃, Sb₂O₄, Sb₂O₅, or MgO.

9. The secondary battery according to claim 1, wherein the undercoating layer further comprises a binder and a conductive agent; based on the mass of the undercoating layer, a mass percentage of the binder is W2, and a mass percentage of the conductive agent is W3, wherein 0.5%≤W2≤25%, and 0.5%≤W3≤20%.

10. The secondary battery according to claim 9, wherein the binder satisfies at least one of the following characteristics:
(1) the binder comprises a polymer formed by monomers of at least one of acrylic acid, acrylamide, lithium acrylate, sodium acrylate, acrylonitrile, methyl acrylate, ethyl acrylate, methyl 2-methacrylate, or ethyl 2-methacrylate;
(2) the binder comprises at least one of sodium carboxymethyl cellulose, potassium carboxymethyl cellulose, or nitrile rubber; or
(3) a weight-average molecular weight of the binder is from 150,000 to 1,950,000.

11. The secondary battery according to claim 9, wherein the conductive agent comprises at least one of graphene, graphite fibers, carbon nanotubes, or conductive carbon black.

12. The secondary battery according to claim 1, wherein the negative electrode plate comprises a negative electrode active material; the negative electrode active material comprising at least one of natural graphite, artificial graphite, mesocarbon microbeads, hard carbon, soft carbon, silicon, or silicon-based composite materials.

13. An electronic device, comprising a secondary battery, the secondary battery comprises a positive electrode plate, a negative electrode plate, and an electrolyte; the positive electrode plate comprising a positive electrode current collector, and an undercoating layer and a positive electrode active material layer are disposed on at least one surface of the positive electrode current collector, wherein the undercoating layer is disposed between the positive electrode current collector and the positive electrode active material layer; and the undercoating layer comprises an inorganic metal oxide, the inorganic metal oxide comprising element M, and the element M comprising at least one of Al, Ti, Sn, Sb, or Mg; based on a mass of the undercoating layer, a mass percentage of the inorganic metal oxide is W1, wherein 55%≤W1≤99%; and
the electrolyte comprises a first compound; the first compound comprising at least one of fluorinated ethylene carbonate, difluorinated ethylene carbonate, a compound represented by formula (I), a compound represented by formula (II), or a compound represented by formula (III), 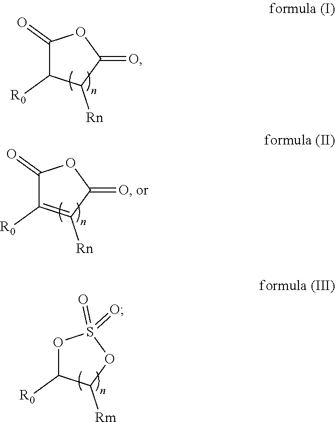
wherein n and m are independently selected from integers from 1 to 3, and R0, Rn, and Rm are each independently selected from hydrogen, fluorine, a substituted or unsubstituted C1-C6 alkyl group, or a substituted or unsubstituted C2-C6 alkenyl group;
and during substitution, a substituent of each group is a halogen; and
based on a mass of the electrolyte, a mass percentage of the first compound is a %, wherein 0.15≤a≤21.

14. The electronic device according to claim 13, wherein the element M comprises at least one of Ti, Sn, or Sb.

15. The electronic device according to claim 13, wherein the secondary battery satisfies at least one of the following characteristics:
$$0.5 ⩽ a ⩽ 12 ; or \qquad ( 1 )$$
$$60 \% ⩽ W 1 ⩽ 85 \% . \qquad ( 2 )$$

16. The electronic device according to claim 13, wherein a thickness of the undercoating layer is A μ m, wherein 2.1≤A≤15.5.

17. The electronic device according to claim 16, wherein 0.02≤a/A≤5.1.

18. The electronic device according to claim 13, wherein the compound represented by formula (I) comprises at least one of succinic anhydride, glutaric anhydride, or adipic anhydride; the compound represented by formula (II) comprises at least one of maleic anhydride, citraconic anhydride, trifluoromethyl maleic anhydride, dimethyl maleic anhydride, 3-fluorofuran-2,5-dione, or 3,4-difluoromaleic anhydride; and the compound represented by formula (III) comprises at least one of ethylene sulfate, propylene sulfate, butylene sulfate, 1,3,2-dioxathiane-2,2-dioxide, or 2-methyl-1,3-propane disulfonate.

19. The electronic device according to claim 13, wherein the inorganic metal oxide comprises at least one of Al₂O₃, TiO₂, SnO₂, SnO, Sb₂O₃, Sb₂O₄, Sb₂O₅, or MgO.

20. The electronic device according to claim 13, wherein the undercoating layer further comprises a binder and a conductive agent; based on the mass of the undercoating layer, a mass percentage of the binder is W2, and a mass percentage of the conductive agent is W3, wherein 0.5%≤W2≤25%, and 0.5%≤W3≤20%.
